(19) United States
(12) Patent Application Publication
(10) Pub. No.: US 2007/0128386 A1
(43) Pub. Date: Jun. 7, 2007

(54) Laminate structure for sealing channel leakers

(76) Inventors: Anthony Robert Knoerzer, Parker, TX (US); Brad Dewayne Rodgers, Frisco, TX (US); Steven Kenneth Tucker, Hurst, TX (US)

Correspondence Address: CARSTENS & CAHOON, LLP, P O BOX 802334, DALLAS, TX, 75380, US

(21) Appl. No.: 11/294,313

(22) Filed: Dec. 5, 2005

(51) Int. Cl. B32B 27/08

(52) U.S. Cl. 428/35.2; 428/35.7

(57) ABSTRACT

In the disclosed invention, a laminate film for a food package comprises a high melt polymer that flows, upon pressure and/or temperature from sealing jaws, into triangular areas created by overlapping films. In one aspect, the high melt polymer comprises a melt index of between about 10 dg/min and about 50 dg/min. In one aspect, the high melt polymer is disposed between two skin layers. The innovative laminate provides the advantage of a simple, economical method of sealing areas that have previously been recalcitrant.

### BACKGROUND OF THE INVENTION

1. Technical Field

The present invention relates to the packaging of a product in a heat-sealable pouch, and more particularly to caulking pinhole leaks to increase the freshness and shelf life of a packaged food product.

2. Description of Related Art

Many snack foods, like chips, pretzels, etc., are packaged in pouches formed of very thin packaging films. These pouches can be manufactured on vertical form, fill, and seal packaging machines that, as their name implies, forms a package, fills it with a product, and seals the filled package.

One such packaging machine is seen diagrammatically in FIG. 1. Packaging film 110 is taken from a roll 112 of film and passed through tensioners 114 that keep it taut. The film then passes over a former 116, which directs the firm into a vertical tube around a product delivery cylinder 118. As the tube is pulled downward by drive belts 120, the vertical tube of film is sealed along its length by a vertical sealer 122, forming a back seal 124. The machine then applies a pair of heat-sealing jaws 126 against the tube to form a transverse seal 128. This transverse seal 128 acts as the top seal on the bag 130 below the sealing jaws 126 and the bottom seal on the bag 132 being filled and formed above the jaws 126. After the transverse seal 128 has been formed, a cut is made across the sealed area to separate the finished bag 130 below the seal 128 from the partially completed bag 132 above the seal. The film tube is then pushed downward to draw out another package length. Before the sealing jaws form each transverse seal, the product to be packaged is dropped through the product delivery cylinder 118 and is held within the tube above the transverse seal 128.

There are three main parameters of the sealing mechanism that are typically changed to correct improper sealing of a bag: temperature, pressure, and dwell time (the time the seal jaws are closed to form the seal). The materials used generally seal within a given range of temperatures, such as 375-425° F., although this range can vary, depending on the accompanying pressure and dwell time. Of these three variables, the pressure is generally set at the factory by a mechanic, and is not easily changeable. A typical pressure would be about 300 pounds of pressure across the entire facing, with the pressure generally fairly evenly distributed across the entire facing. Thus, for an eight-inch wide bag, there can be approximately eight square inches of packaging contacted when making the top/bottom seal or a pressure of about 37.5 pounds per square inch for a seal that is ½ inch wide.

Typical back seals formed using the film composition shown in FIG. 1 are illustrated in FIGS. 2a and 2b. FIG. 2a is a schematic of a “fin seal” embodiment of a back seal being formed on a tube of film. FIG. 2b illustrates a “lap seal” embodiment of a back seal being formed on a tube of film.

With reference to FIG. 2b, a portion of the inside sealant layer 208 is mated with a portion of the outside layer 202 in the area indicated by the arrows to form a lap seal. The seal in this area is accomplished by applying heat and pressure to the film in such area. In the embodiment shown in FIG. 2a, the inside sealant layer 208 is folded over and then sealed on it, as indicated by the arrows. Again, this seal is accomplished by the application of heat and pressure to the film in the area illustrated.

In contrast to the factory-set pressure, the temperature and dwell time are operator decisions at the time the product is packaged. The operator will generally be familiar with the specific materials being used for a package and can vary the time and temperature parameters as needed to obtain an effective seal, within the constraints of the situation. One such constraint is that increasing the temperature past a given range for a material can result in burning, or melting a hole through the material. An additional constraint is the effective throughput of a machine, which can be affected by the dwell time. For instance, if a seal formed at a given temperature and pressure is not holding after 1/10 of a second, increasing the dwell time of the sealing mechanism to ⅕ second, or even ½ second, may significantly improve the seal, but it may also mean that the machine can only package a fraction of the product it can handle at a lower dwell time. A dwell time that requires additional machines to meet a production schedule is not an economic solution.

A typical film used for packaging snack foods is seen in FIG. 3a. The outermost layer 310 is an OPP, short for oriented polypropylene, while the innermost or product side layer 360 is a metalized OPP. An oriented polymer material has been specially treated so that the molecules tend to align in a given direction, causing the material to tend to preferentially tear in that direction. Sandwiched between the two OPP layers is a polyethylene layer 330. The innermost, metallic layer 360 can itself be a layered laminate and contains a sealant layer 380 on what will be the inside of the package. This sealant layer is typically composed of a ter-polymer, composed of ethylene, propylene, and butylene. The bag is sealed by bringing together two sections of the metallic layer, with their sealant layers together. When heat and pressure are applied through the jaws, the adjacent sealant layers melt together and form a seal. Other materials used in packaging are polyester, paper, polyolefin extrusions, adhesive laminates, and other such materials, or a layered combination of the above.

The OPP layers of the packaging material can be separately manufactured and formed into the final material on a laminator as seen in FIG. 3b. In this example, the material 300 output from the laminator is the same material discussed in FIG. 3a above. An OPP sheet 310 comprising an ink layer 320 is fed from roll 301 and will become the outer layer 310 of the material 300 shown in FIG. 3a. Likewise a metallic OPP sheet 360 of material having a sealant layer 380 is fed from roll 302 and will become the inner layer 360 of the material 300. At the same time, resin for PE laminate layer 330 (shown in FIG. 3a) is fed into hopper 318 (shown in FIG. 3b) and through extruder 316 to be heated to approximately 600 degree F. and extruded at die 314 as a molten sheet of resin 335. This molten sheet of resin 335 is extruded at a rate that is congruent with the rate at which the sheet materials 310 360 are fed, becoming sandwiched between these two materials to form PE laminate layer 330. The material 300 then runs between chill drum 312 and nip roller 313, ensuring that it forms an even layer as it is cooled. The pressure between the laminator rollers tends to be in the range of 0.5 to 5 pounds per linear inch across the width of the material. The large chill drum 312 is made of stainless steel and is cooled to about 50-100 degree F., so that while the material is cooled quickly, no condensation is allowed to form. Note that the layered material remains in contact with the chill drum 312 for a period of time after it has passed through the rollers, to allow time for the resin 335 to cool sufficiently. The material can then be formed into rolls (not specifically shown) for transport to the location where it can be placed on a roll 112, as depicted in FIG. 1 and used in packaging.

Ideally, every seal on every package made from this film would be a hermetic, or leak-proof transverse seals, even under pressure changes. This is especially important with snack foods, so that flavor and freshness are preserved. FIG. 5 depicts a prior art pillow pouch illustrating relative position of the problem area 442 where leaks tend to develop in the transverse seal. The area where the package has an outer lap seal overlap 232 provide extra layers of material in the seal and can create a void 440 and result in a pinhole leaks through the transverse seal 442. This problem can become more acute with thicker packaging materials and smaller packages.

FIG. 4a shows a cross-section along the length of a pair of prior art crimper jaws 400 having a bag 450 with a fin seal that is about to be sealed between the jaws 400. In this drawing, the areas near the back seal and the gusset are enlarged to form FIG. 4c. As shown in FIG. 4c, the film tube comprises a first portion of film 220 sealed to a second portion of film 222 to form the fin seal. The first and second portion of film is then sealed to an adjacent sealing film 224. In FIG. 4d, each of these locations is then shown again after the seal has been made. Referring to FIG. 4c, an arrow points to the small area where triangular capillary leaks tend to occur and FIG. 4d depicts the resultant triangular capillary area or void space 440. As can be seen in these enlargements, the immediate areas where the number of layers changes is the most likely location for a leak.

FIG. 4b shows a cross-section along the length of a pair of prior art crimper jaws 400 having a bag 450 with a lap seal that is about to be sealed between the jaws 400. In this drawing, the areas near the back seal and the gusset are enlarged to form FIG. 4e. As shown in FIG. 4e, the film tube comprises a first portion of film 230 sealed to a second portion of film 232 to form the lap seal. The first and second portion of film is then sealed to an adjacent sealing film 234. In FIG. 4f, each of these locations is then shown again after the seal has been made, with an arrow pointing to the small area where triangular capillary leaks tend to occur in FIG. 4e and the resultant triangular capillary area or void space 440 in FIG. 4f. As can be seen in these enlargements, the immediate areas where the number of layers changes is the most likely location for a leak. Microscopy analysis has indicated capillary areas in the range of 50 to 100 microns can be formed in this area on a lap seal.

Lap seals are more desirable than fin seals for packaging because less material is required to make the same size package. Consequently, use of lap seals is more economical from a cost of packaging film standpoint. However, lap seals have a tendency to leak in the trouble areas. While it is probably impossible to totally eliminate leakers in the production line, the goal is always to achieve a vanishingly small number of them.

Consequently, a need exists to reduce the number of leaking packages produced in the production line without increasing dwell time, without modifications to the bag maker, and without increased costs.

### SUMMARY OF THE INVENTION

The invention provides a multilayered film for a package which comprises a high melt characteristic polymer disposed between a first or outer facing layer and a second or product facing layer. In one aspect, the high melt characteristic polymer has properties such that a portion of the high melt polymer flows, upon application of heat and/or pressure from sealing jaws, into a void space created by overlapping layers. In one aspect, once the sealing jaws are removed, the high melt polymer solidifies and caulks a channel in the transverse seal that could otherwise provide communication between the inner package and the outer environment.

The multilayer film and food package is a substantial improvement over prior art laminate films. The film can be used on existing vertical form and fill machines with no modification to the machines. Similarly, the cost of the film of the present invention is substantially similar to the cost of prior art films. The present invention can thereby produce a package that can preserve and enhance the shelf life of food and non-food oxygen sensitive items.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a diagrammatic view of a form, fill, and seal machine, known in the prior art.

FIG. 2a is a schematic cross-section view of a tube of packaging illustrating the formation of a prior art fin seal.

FIG. 2b is a schematic cross-section view of a tube of packaging illustrating the formation of a prior art lap seal.

FIG. 3a shows the layers in a typical packaging material for snack foods.

FIG. 3b shows a laminator as it bonds two layers of film together.

FIG. 4a shows a top cross-section along the length of a pair of prior art crimper jaws having a bag with a fin seal that is about to be sealed between the jaws.

FIG. 4b shows a top cross-section along the length of a pair of prior art crimper jaws having a bag with a lap seal that is about to be sealed between the jaws.

FIGS. 4c and 4d demonstrate the problem areas on a fin seal bag where pinhole leaks tend to occur.

FIGS. 4e and 4f demonstrate the problem areas on a lap seal bag where pinhole leaks tend to occur.

FIG. 5 depicts a prior art pillow pouch illustrating relative position of the problem areas.

FIG. 6 show the layers of the laminate packaging film in accordance with one embodiment of the present invention.

FIG. 7a depicts an exaggerated cutaway perspective view of the laminate packaging film of the present invention and the direction of flow of the high melt polymer in accordance with one embodiment of the present invention.

FIG. 7b depicts an exaggerated top cross-section of the intersection of the three layers of laminate packaging films in accordance with one embodiment of the present invention.

FIG. 8 depicts the pillow pouch made from a laminate material in accordance with one embodiment of the present invention.

FIG. 9 is a comparative graphical representation comparing the percentage of oxygen over a period of time in a package made from the prior art film and a package made from film in accordance with the present invention.

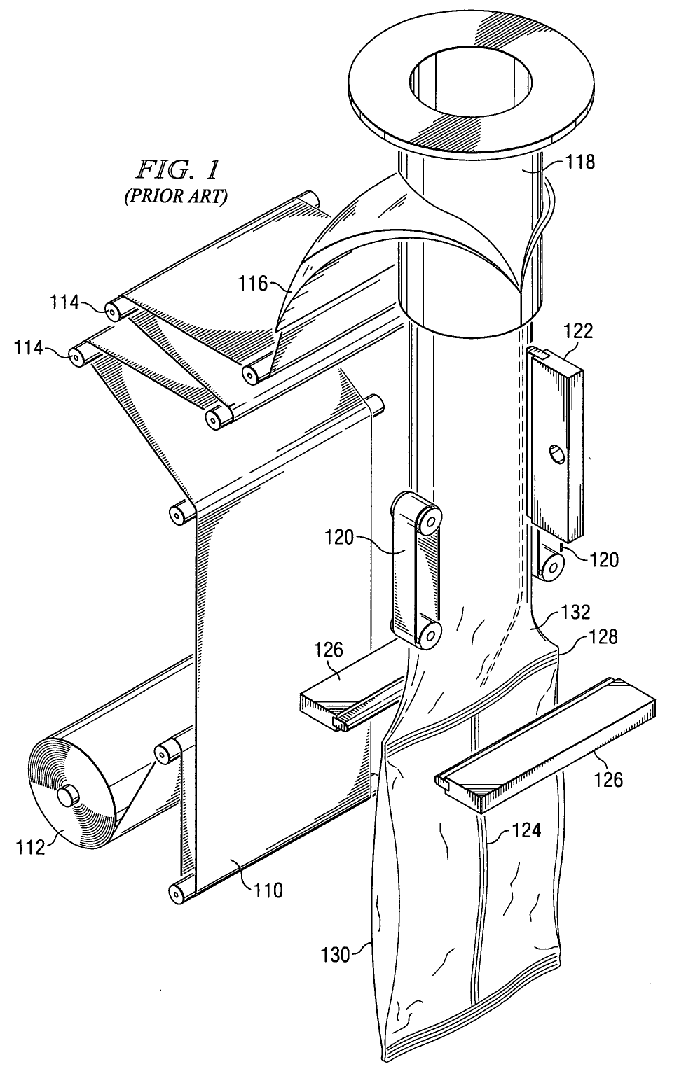

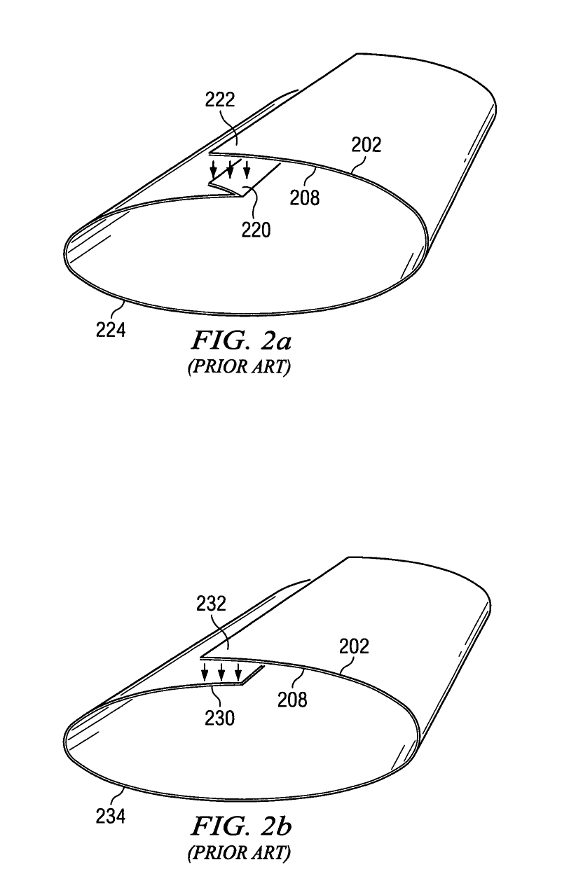

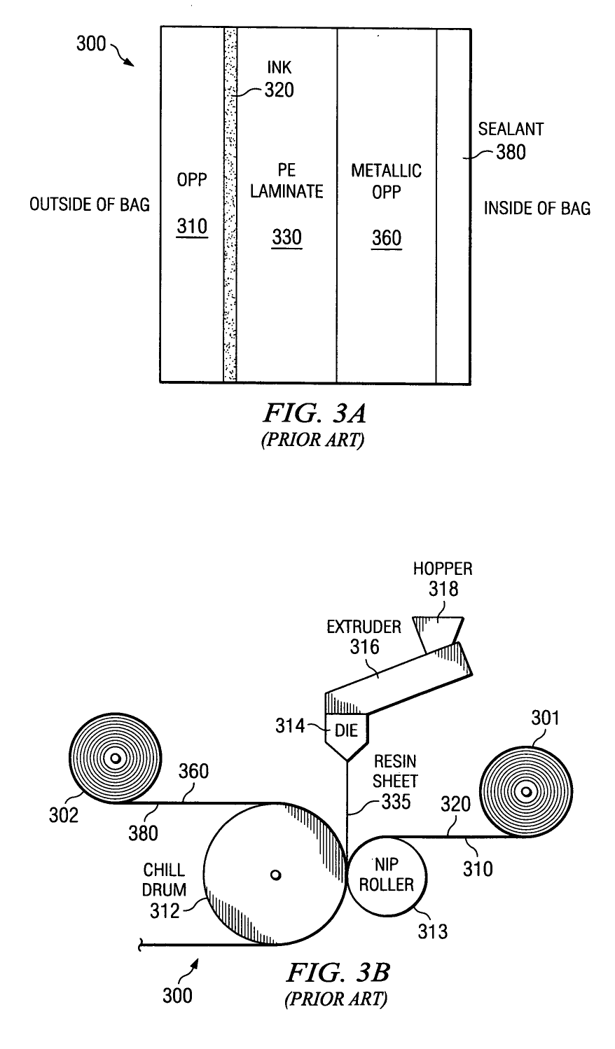

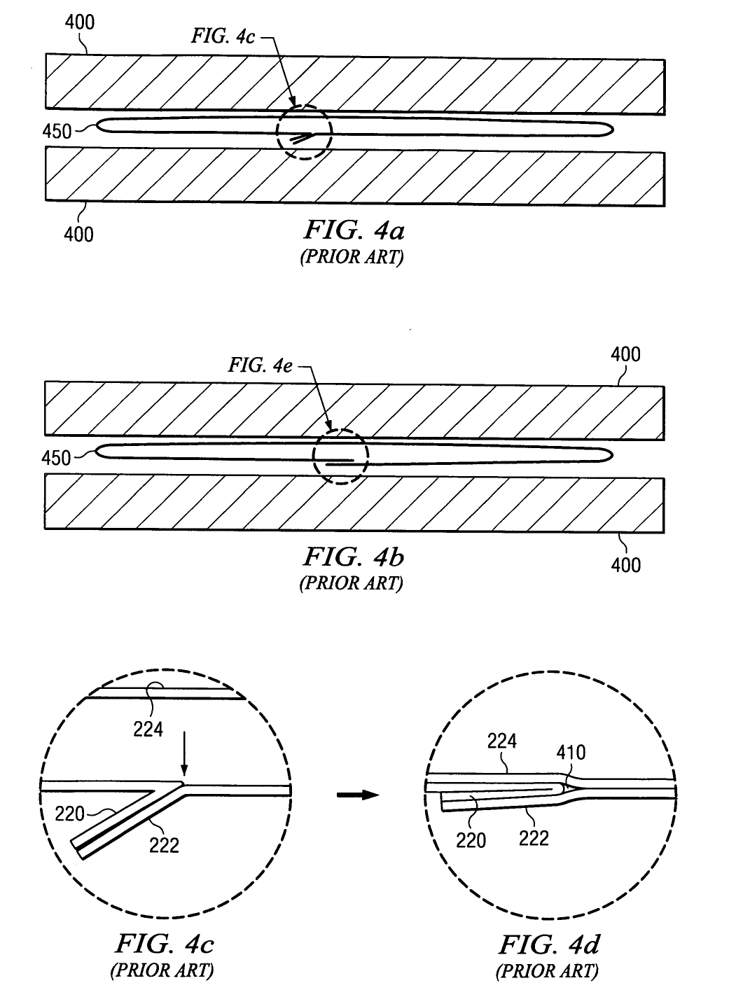

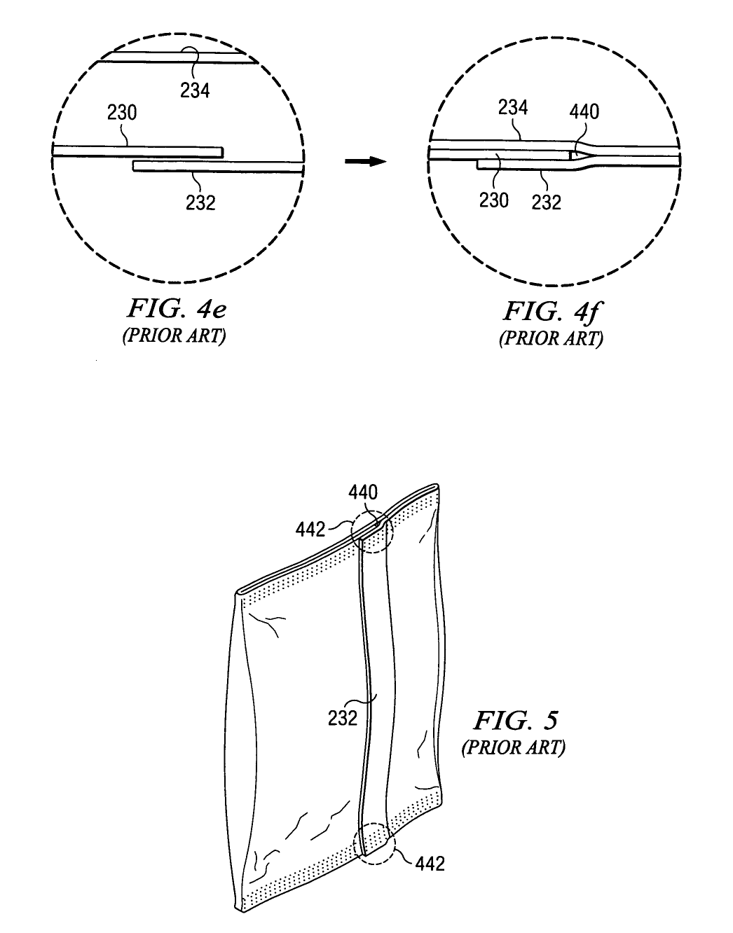

### DETAILED DESCRIPTION

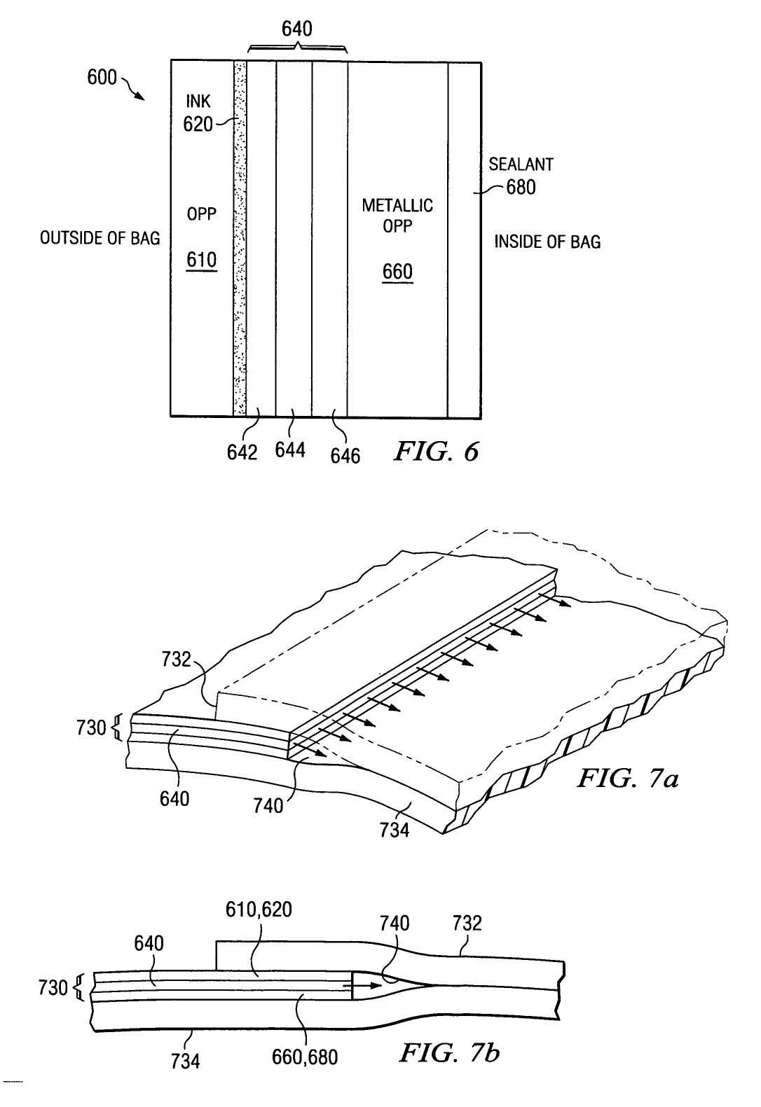

The present invention provides a film layer for use in forming food packages, where the film layer has a high melt characteristic that flows into a void in a layer intersection area where the number of layers change at the transverse seal. Referring now to FIG. 6, a cross-sectional view of a multi-layer film in accordance with an embodiment of the present invention is illustrated. A core layer 640 is bounded by a first skin layer 610 and a second skin layer 660. In the embodiment shown, the first skin layer 610 further comprises an ink layer 620 and the second skin layer 660 further comprises a sealant layer 680.

The first skin layer 610 can be any olefin polymer known in the art including, but not limited to polyester, polyethylene including high density polyethylene (HDPE), low density polyethylene (LDPE), linear low density polyethylene (LLDPE), and polyethylene terephthalate (PET). In one embodiment, the first skin layer comprises oriented polypropylene (OPP), which is well known in the art.

The second skin layer 660 can be any olefin polymer known in the art including, but not limited to polyester, polyethylene including HDPE, LDPE, LLDPE, and PET. In one embodiment, the second skin layer comprises a metalized polymer such as polypropylene (PP) including OPP or metalized PET. Metalized polymer films are polymer films with a metal layer, such as aluminum, formed thereon. Methods for making metalized PP, metalized PET and other metalized polymer films are known.

The sealant layer 680 of the package wall functions to seal the open ends of the package. Typically, this sealant function is accomplished because of the temperature at which the package is finally formed. The sealant layer 680 is formed of a composition that melts at a lower temperature than the substances forming the other layers of the package wall. The melting of the sealant layer 680 seals the package, while the remaining layers of the package wall are not melted. Melting of the remaining layers of the package wall is not desirable because such melting would cause the package to stick to the machinery used to form the package, and would result in the formation of disfigured packages. The sealant layer 680 is typically comprised of a ter-polymer blend, namely, polyethylene, polypropylene and polybutene. Other polymers and polymer blends may be used, however, as long as such blends allow for the sealant function. In one embodiment a sealant layer 680 disclosed in U.S. Pat. No. 6,833,170 can be used.

FIG. 7a depicts an exaggerated cutaway perspective view of the laminate packaging film at the present invention and the direction of flow of the high melt polymer in accordance with one embodiment of the present invention. FIG. 7b depicts an exaggerated top cross-section of the intersection of the three layers of laminate packaging films in accordance with one embodiment of the present invention. An outer lap seal overlap 732 overlaps and is sealed to a portion of the inner lap seal overlap 730. A first portion of the adjacent sealing film 734 is sealed to the inner lap seal overlap 730 and a second portion of the adjacent sealing film 734 is sealed to the outer lap seal overlap 732. A capillary void space 740 is formed where the adjacent sealing film 734 transitions from the first portion to the second portion. In one embodiment, the core layer 640 comprises a polymer having a flow characteristic such that a portion of the polymer flows into the capillary void space 740 as shown by the direction of the arrows in FIGS. 7a and 7b upon application of pressure from the heat-sealing jaws when the transverse seal is made. In such embodiment, the capillary void space 740 is thereby filled with a polymer that effectively caulks and thereby seals the capillary void area 740. Consequently, oxygen transmission into the package from pinhole leaks in this area can be substantially reduced or eliminated.

The desired flow characteristics of the core layer 640 can be achieved with the proper combination of melt index and/or the melting point of the polymer. The melt index is a reflection of the molecular weight of the material or the length of its hydrocarbon chains. The longer the hydrocarbon chains, the higher the molecular weight, the more viscous and tough the material, and the lower the melt index. As used herein a melt index is measured by ASTM D-1238, at 190° C. under a total load of 2.16 kg. As the melt index of a polymer increases, its ability to flow increases as well. Thus, in accordance with the present invention, the core layer 640 comprises a high melt index polymer. As used herein, a high melt index is defined as a polyolefin resin having a melt index of between about 10 dg/min and about 50 dg/min. Several types of polyolefin polymer or polyolefin resins have such a melt index and include, but are not limited to LDPE resins, LLDPE resins, HDPE resins, and ethylene copolymers such as ethylene-acrylic acid, ethylene methyl acrylic acid, ethylene acrylate, methyl acrylate, ethyl acrylate, vinyl acetate, and mixtures thereof. Manufacturers of such materials include Dow Chemical, Eastman Chemical, CP Chemical, and Westlake. In one embodiment, the core layer 640 comprises a polyolefin resin having a melt index of between about 10 dg/min and about 50 dg/min. In one embodiment, the core layer 640 comprises a polyolefin resin having a melt index of greater than about 13 dg/min. In one embodiment, the core layer 640 comprises a polyolefin resin having a melt index of less than about 20 dg/min.

In addition to melt index, a polymer having a lower melting point causes the polymer in the core layer 640 to flow earlier, which can facilitate flow into the void space and/or help to minimize required dwell times when sealing the laminate film. Thus, in one embodiment of the present invention, the core layer 640 comprises a melting point of between about 60° C. and about 140° C.

The melting point of a polymer resin can be lowered by polymerization and the amount the melting point is lowered can be dependent upon the copolymer type or catalyst type that is used. Metallocene polyolefins are homogenous linear and substantially linear ethylene polymers prepared using single-site or metallocene catalysts. It is known that polyolefins made from supported metallocene catalyst systems tend to result in a polymers having lower melting point than would otherwise be obtained if the metallocene were not supported. Consequently, in one embodiment of the present invention, the core layer 640 comprises a metallocene polyolefin obtained by the copolymerization of an ethylene including HDPE or LLDPE with an alpha olefin such as 1-butene, 1-hexene, and 1-octene.

The amount of a polymer used in a laminate can be defined by the coating weight. As used herein, the coating weight is the weight of the polymer applied per unit area of application. In one embodiment, the core layer 640 comprises a high melt index polymer having a coating weight of between about 1 and about 14 pounds per ream. In one embodiment, the core layer 640 comprises a high melt index polymer having a coating weight of between about 4 and about 8 pounds per ream. In one embodiment, the core layer 640 comprises a high melt index polymer wherein the high melt index polymer is greater than about 0.1 mils thick. In one embodiment, the core layer 640 comprises a high melt index polymer wherein the high melt index polymer is less than about 1.0 mils thick. In one embodiment, the core layer 640 comprises a high melt index polymer between about 0.2 and about 0.6 mils thick.

In one embodiment, the proper combination of melt index and melting point can be provided by one or more polymer layers 642 644 646 within the core layer 640. For example, in one embodiment, the core layer 640 comprises a three layer co-extruded film having a high flow resin 644 or middle layer sandwiched between two layers 642 646. In one embodiment, the layers 642 646 comprise low density polyethylene. As used herein, a high flow resin corresponds to a resin having a high melt index. Using multiple layers permits the laminator to coextrude a high flow resin with a more extrusion stable material so that the packaging film can be manufactured efficiently while delivering the desired caulking effect during the subsequent sealing process.

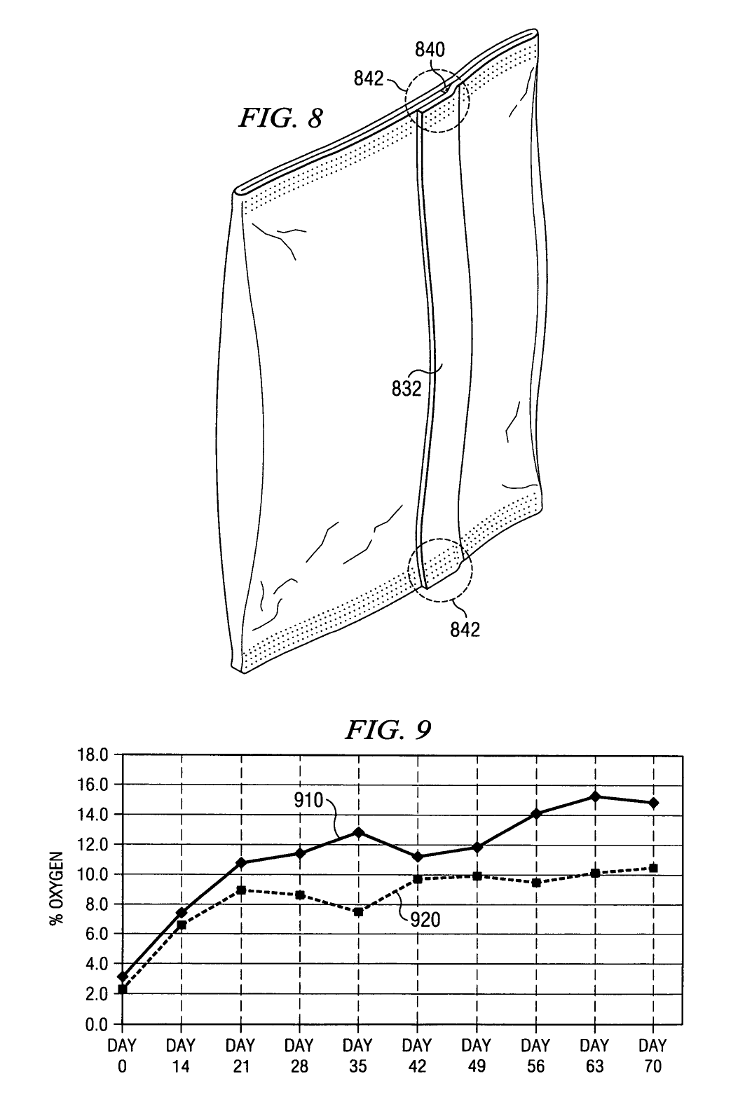

FIG. 8 depicts the pillow pouch made from a laminate material in accordance with one embodiment of the present invention. By incorporating a film layer with a high flow characteristic into at least the core layer of a packaging film wall, the present invention reduces the pinhole leaks that can occur in the locations depicted by numeral 842 at the transverse seal where a back seal in the form of a fin seal or lap seal 832 is formed. When the sealing jaws apply heat and pressure to the transverse seal, sufficient energy is imparted to cause a portion of the core layer to flow into the void space 840. The void space 840 is consequently filled or caulked by the core layer. After the sealing jaws have released, the polymer in the void space solidifies and plugs the pinhole leak. The reduction in pinhole leaks reduces or slows oxygen transmission from the outside environment to the food product, increasing product freshness and shelf life.

The flexible thin films assembled in the embodiments of FIG. 6 may be arranged any number of ways depending on the particular packaging application. Furthermore, the flexible thin films of the present invention are of the type commonly employed in the art to produce flexible packages using a typical form, fill, and seal packaging machine, and are typically constructed of thin film layers of up to about 150 gauge thickness (1.5 mils or 0.0015 inches). The desired product environment to be maintained within a package drives the types and arrangements of thin films that are chosen for a particular packaging application. Other considerations include desired shelf life and cost. A plurality of package designs is possible, depending on the preceding factors. The materials making up the film layers, primarily plastics, are well known in the art. Examples of such materials are various vinyl, metalized, and polymer extrusion films, and various adhesives, ties, and bonding agents for fixing the thin film layers together. These materials vary in cost, as well as in their physical characteristics, such as flexibility, strength, and permeability to substances that decrease the shelf life of a food product, such as oxygen, moisture, and light.

One advantage of the present invention is the reduced oxygen transfer rate and greater shelf life. Such advantage is evidenced by the comparative Example provided below.

### EXAMPLE

A commercially available prior art film was used to make several vending machine sized bags (“Control Set”) filled with LAYS brand potato chips on Day 0. The prior art film had a MARFLEX 1017 (available from Chevron Phillips Chemical) laminating resin or core layer with a melt index of 7 dg/min. Additional bags (“Test Set”) were made from the inventive film on Day 0 and also filled with LAYS brand potato chips. The inventive film used a MARFLEX 1019 (also available from Chevron Phillips Chemical) laminating resin or core layer with a melt index of 16 dg/min. The packages were stored in controlled storage conditions. For the first four weeks, the packages were stored at 85° F. at 80% relative humidity and were then stored at 73° F. at 50% relative humidity for the remainder of the test. Several bags from the Control Set and Test Set were tested for oxygen levels at Day 0, Day 14, Day 21, Day 28, Day 35, Day 42, Day 49, Day 56, Day 63, and Day 70. The averages for each of these test sets were graphically plotted.

FIG. 9 is a comparative graphical representation comparing the percentage of headspace oxygen over a period of time in a package made from the prior art film control set 910 and a package made from inventive film test set 920 in accordance with the present invention. One advantage of the present invention is the reduced oxygen transfer rate and greater shelf life. The oxygen ingress or oxygen transfer rate equals the oxygen transfer rate through the bag material plus the leak rate. In this example a lowered leak rate resulted in greater shelf life. In one embodiment, consumers indicated product that had been packaged from prior art material was undesirable after 35 to 42 days and indicated product in accordance with the present invention was acceptable up to 56 days. This shelf-life improvement provides a significant marketing advantage in a competitive environment. In addition, the invention accomplishes its purpose with minimal additional material and manufacturing costs.

It is also believed that the film of the present invention can also be useful in a fin seal package because the pressure and temperature provided by the sealing jaws during the sealing can cause a thinning of the thickness of the laminate film in areas where more layers are present and a thickening of the thickness of the laminate film in the adjacent area where there are fewer layers as the polymer flow within the core layer moves laterally, thus minimizing the capillary void space.

As used herein, the term “package” should be understood to include any food container made up of multi-layer thin films. The sealant layers, thin films, and films with a high melt core layer as discussed herein are particularly suitable for forming packages for snack foods such as potato chips, corn chips, tortilla chips and the like. However, while the layers and films discussed herein are contemplated for use in processes for the packaging of snack foods, such as the filling and sealing of bags of snack foods, the layers and films can also be put to use in processes for the packaging of other foods. While the invention has been particularly shown and described with reference to a preferred embodiment, it will be understood by those skilled in the art that various changes in form and detail may be made therein without departing from the spirit and scope of the invention.

What is claimed is:

1. A multilayer film, comprising:
a) a core layer having a first side and a second side, said core layer comprising a polyolefin having a melt index of between about 10 dg/min and about 50 dg/min;
b) a first skin layer continuous to and in contact with the first side of the core layer; and
c) a second skin layer contiguous to and in contact with the second side of the core layer.

2. The multilayer film of claim 1 wherein said core layer consists of one or more polymer resins selected from the group consisting of:
a high melt index LDPE resin, said LDPE resin having a melt index of between about 10 dg/min and about 50 dg/min,
a high melt index LLDPE resin, said LLDPE resin having a melt index of between about 10 dg/min and about 50 dg/min,
a high melt index HDPE resin, said HDPE resin having a melt index of between about 10 dg/min and about 50 dg/min,
an ethylene copolymer, said ethylene co-polymer having a melt index of between about 10 dg/min and about 50 dg/min,
a metallocene polyolefin having a melt index of between about 10 dg/min and about 50 dg/min, wherein said polyolefin is obtained by the copolymerization of LLDPE with an alpha olefin, and
a metallocene polyolefin having a melt index of between about 10 dg/min and about 50 dg/min, wherein said polyolefin is obtained by the copolymerization of HDPE with an alpha olefin.

3. The multilayer film of claim 1 wherein said polyolefin comprises a thickness greater than about 0.1 mils.

4. The multilayer film of claim 1 wherein said polyolefin comprises a thickness of less than about 1.0 mils.

5. The multilayer film of claim 1 wherein said polyolefin comprises a coating weight of more than about 1 pound per ream.

6. The multilayer film of claim 1 wherein said polyolefin comprises a coating weight of less than about 14 pounds per ream.

7. The multilayer film of claim 1 wherein said polyolefin comprises a melting point of less than about 140° C.

8. The multilayer film of claim 1 wherein said polyolefin comprises a melting point of greater than about 60° C.

9. The multilayer film of claim 1 wherein said core layer further comprises one or more polymer layers.

10. The multilayer film of claim 1 wherein said core layer further comprises a high flow resin sandwiched between two layers.

11. The multilayer film of claim 10 wherein said core layer comprises a three layer co-extruded film.

12. A food package comprising:
a first thin film forming the product side of a wall of the food package;
a second thin film to which said first thin film is laminated, said second thin film comprising a high flow characteristic such that a portion of said second thin film caulks a void at a transverse seal; and
a third thin film laminated to said second thin film.

13. The food package of claim 12 wherein said second thin film comprises a melt index of between about 10 dg/min and about 50 dg/min.

14. The food package of claim 13 wherein said second thin film consists of one or more polymer resins selected from the group consisting of:
a high melt index LDPE resin, said LDPE resin having a melt index of between about 10 dg/min and about 50 dg/min,
a high melt index LLDPE resin, said LLDPE resin having a melt index of between about 10 dg/min and about 50 dg/min,
a high melt index HDPE resin, said HDPE resin having a melt index of between about 10 dg/min and about 50 dg/min,
an ethylene copolymer, said ethylene co-polymer having a melt index of between about 10 dg/min and about 50 dg/min,
a metallocene polyolefin having a melt index of between about 10 dg/min and about 50 dg/min, wherein said polyolefin is obtained by the copolymerization of LLDPE with an alpha olefin, and
a metallocene polyolefin having a melt index of between about 10 dg/min and about 50 dg/min, wherein said polyolefin is obtained by the copolymerization of HDPE with an alpha olefin.

15. The food package of claim 12 wherein said polyolefin comprises a thickness of greater than about 0.1 mils.

16. The food package of claim 12 wherein said polyolefin comprises a thickness of less than about 1.0 mils.

17. The food package of claim 12 wherein said polyolefin comprises a coating weight of more than about 1 pound per ream.

18. The food package of claim 12 wherein said polyolefin comprises a coating weight of less than about 14 pounds per ream.

19. The food package of claim 12 wherein said second thin film further comprises a three layer co-extruded film having a middle layer wherein said middle layer comprises a high melt index.

20. The food package of claim 12 wherein said second thin film comprises a melting point of between about 60° C. and about 140° C.

21. The food package of claim 12 wherein said second thin film comprises a co-extruded high flow resin.
